(19) United States
(12) Patent Application Publication
(10) Pub. No.: US 2026/0367961 A1
(43) Pub. Date: Nov. 19, 2026

(54) AUTOMATED ISSUE RESOLUTION LEARNING FOR AN INTENT MANAGER

(71) Applicant: Telefonaktiebolaget LM Ericsson (publ), Stockholm (SE)

(72) Inventors: Mirko D'ANGELO, Göteborg (SE); Dinand ROELAND, SOLLENTUNA (SE); Amadeu Do Nascimento JUNIOR, INDAIATUBA (BR)

(21) Appl. No.: 19/148,089

(22) PCT Filed: Jan. 31, 2023
(86) PCT No.: PCT/EP2023/052338

§ 371 Date: Jul. 15, 2025

(51) Int. Cl. G06F 9/48

(52) U.S. Cl. CPC G06F 9/4806

(57) ABSTRACT

A method performed by an intent manager that controls an environment based on an intent for the environment includes receiving information about the environment. Based on the information, the method identifies an issue in the environment that needs to be addressed to achieve the intent, and obtains an efficiency graph associated with the issue. The efficiency graph indicates an efficiency score of a proposal agent at generating proposed actions on the environment to address the issue. Based on the efficiency score, the proposal agent is invoked to generate a proposed action on the environment to address the issue. The method determines whether or not the proposed action generated by the proposal agent is selected for implementation on the environment, and adjusts the efficiency score of the proposal agent based on whether or not the proposed action was selected for implementation on the environment.

### TECHNICAL FIELD

The present disclosure relates to systems and methods for controlling an environment, and in particular to intent management functions, and in particular to systems and methods for controlling an environment using zero touch control.

### BACKGROUND

An intent manager (IM) provides zero-touch control for an environment. “Zero touch control” refers to a system or process that can be automatically configured and managed without the need for human intervention. The term is often used in the context of networking and information technology, where zero touch provisioning allows for new devices to be added to a network without the need for manual configuration. See, for example, “Intent-Based Networking —Concepts and Definitions” published by the Internet Engineering Task Force (IETF). This can be done through the use of pre-configured settings, remote management tools, or other automation techniques. The goal of zero touch control is to reduce the time and resources required to manage and maintain complex systems.

Referring to FIG. 1, an intent manager 10 is controlled by one or more intents provided by an operator 12. The intent manager 10 controls one or more environments 20. Controlling an environment 20 is done by observing the environment 20, reasoning based on the combination of the perceived situation in the environment 20 and prior knowledge, and taking actions on the environment 20. These steps may be performed in a closed loop, in which the environment 20 changes based on the actions taken. The overall purpose of the intent manager is to fulfill the intent of the operator.

In this context, the term “intent” refers to the formal specification of all expectations including requirements, goals, and constraints given to an environment. When the environment is a communication system, the expectations may refer to operational metrics or parameters. For example, expectations may be presented as minimum requirements, such as “at least 95% of URLLC (ultra-reliable low latency communication) users shall experience a latency of maximum 20 msec”, or “at least 80% of the users of the conversational video service shall have a minimum QoE (Quality of Experience) of 4.0”, or “Energy consumption of the system shall be kept to a minimum.”

The intent manager 10, which is illustrated at a high level in FIG. 1, can be implemented in a cognitive framework (aka cognitive layer) as illustrated in FIG. 2. As shown therein, the intent manager 10 generally includes a knowledge base 32 and plurality of agents, including one or more data grounding agents 34a, proposal agents 34b, evaluation agents 34c and actuator agents 34d.

One or more intents are sent to the intent manager 10. Each expectation in an intent may be treated as a Key Performance Indicator (KPI) that needs to be met, referred to as a target KPI. Raw data is exposed from the environment and processed by data grounding agents 34a. The data grounding agents 34a translate the raw data into measured KPIs. Target and measured KPIs can be compared, and the difference becomes an issue or goal that the intent manager needs to meet. For example, the target KPI is “max 20 msec latency” but the measured KPI is “30 msec latency”. One or more proposal agents 34b are responsible for proposing actions that would solve the issue. Evaluation agents 34c make an assessment of whether a proposed action is good or not. Finally, actuator agents 34d execute the action on the environment 20 under control.

When applying the structure of FIG. 2 to a communication network such as a mobile communication network or wireless communication network, the environment 20 under control corresponds to the communication network and the operator may be a human network operator. For scalability reasons, a communication network may be divided into multiple domains (i.e., environments). Furthermore, multiple intent managers may be provided in a hierarchy. In general, the environment under control could be a part of the communication network or could be another intent manager. The operator could be a human network operator or could be another intent manager.

### SUMMARY

A method performed by an intent manager that controls an environment based on an intent for the environment includes receiving information about the environment. Based on the information about the environment, the method identifies an issue in the environment that needs to be addressed to achieve the intent, and obtains an efficiency graph associated with the issue. The efficiency graph indicates an efficiency score of a first proposal agent at generating proposed actions on the environment to address the issue. Based on the efficiency score, the method invokes the first proposal agent to generate a proposed action on the environment to address the issue. The method determines whether or not the proposed action generated by the first proposal agent is selected for implementation on the environment, and adjusts the efficiency score of the first proposal agent based on whether or not the proposed action generated by the first proposal agent was selected for implementation on the environment.

Adjusting the efficiency score of the first proposal agent may include increasing the efficiency score of the first proposal agent in response to the proposed action generated by the first proposal agent being selected for implementation on the environment, and decreasing the efficiency score of the first proposal agent in response to the proposed action generated by the first proposal agent not being selected for implementation on the environment.

In some embodiments, the efficiency score indicates a probability of being invoked to generate a proposed action on the environment to address the issue.

The efficiency score may include a value between 0 and 1 inclusive. In some embodiments, the efficiency score includes a value between L and 1 inclusive, where L is a lower limit of the efficiency score that is greater than zero and less than 1.

In some embodiments, the invoking the first proposal agent to generate the proposed action on the environment to address the issue based on the efficiency score includes invoking the first proposal agent with a probability equal to the efficiency score of the first proposal agent.

In some embodiments, invoking the first proposal agent to generate the proposed action on the environment to address the issue is based on a probability value that is independent of the efficiency score of the first proposal agent.

In some embodiments, invoking the first proposal agent to generate the proposed action on the environment to address the issue is performed with a probability value epsilon without reference to the efficiency score of the first proposal agent and a probability value 1-epsilon based on the efficiency score of the first proposal agent.

The efficiency graph may indicate efficiency scores of a plurality of proposal agents, including the first proposal agent, at generating proposed actions on the environment to address the issue.

The notification may indicate whether or not the proposed actions generated by the plurality of proposal agents were selected for implementation on the environment, and the method may further include adjusting the efficiency scores of each of the plurality of proposal agents based on whether or not the proposed actions generated by the plurality of proposal agents were selected for implementation on the environment.

In some embodiments, the first proposal agent generates a plurality of proposed actions to address the issue, and the efficiency score of the first proposal agent is increased in response to any of the plurality of proposed actions being selected for implementation on the environment.

The environment may include a computerized system, and the information about the environment may include information relating to operation of the computerized system, the intent may include a key performance indicator, KPI, of the computerized system, and the issue may include a failure of the computerized system to achieve the KPI.

The environment may include a communication network, the information about the environment may include information relating to operation of the communication network, the intent may include a key performance indicator, KPI, of the communication network, and the issue may include a failure of the communication network to achieve the KPI. The communication network may be a mobile communication network.

In some embodiments, the issue includes a first issue, and the efficiency graph is associated with a situation that includes a plurality of issues including the first issue.

The method may further include detecting a change in the intent or a change in the issue, and updating the efficiency score in response to the change in the intent or the change in the issue.

Updating the efficiency score may include increasing or decreasing the efficiency score.

In some embodiments, updating the efficiency score includes increasing the efficiency score to a maximum value. In some embodiments, updating the efficiency score includes increasing the efficiency score by a fixed percentage.

The method may further include updating the efficiency score after a predetermined time period has elapsed. Updating the efficiency score may include increasing or decreasing the efficiency score after the predetermined time period has elapsed.

The method may further include adding one or more edges to the efficiency graph based on a model, M, that maps the effect of executed action to the issue.

Some embodiments provide an intent manager that controls an environment based on an intent for the environment. The intent manager includes a reasoner that receives information about the environment and, based on the information about the environment, identifies an issue in the environment that needs to be addressed to achieve the intent. The reasoner obtains an efficiency graph associated with the issue that indicates an efficiency score of a first proposal agent at generating proposed actions on the environment to address the issue. Based on the efficiency score, the reasoner invokes the first proposal agent to generate a proposed action on the environment to address the issue.

The intent manager further includes an evaluation agent that determines whether or not the proposed action generated by the first proposal agent is selected for implementation on the environment, and that notifies the reasoner of whether or not the proposed action generated by the first proposal agent was selected for implementation on the environment. The reasoner adjusts the efficiency score of the first proposal agent based on whether or not the proposed action generated by the first proposal agent was selected for implementation on the environment.

The intent manager may further include a prediction agent that estimates an impact on the environment of the proposed action generated by the first proposal agent, wherein the evaluation agent determines whether or not the proposed action generated by the first proposal agent should be selected for implementation on the environment based on the estimated impact of the proposed action on the environment.

The intent manager may further include an actuator agent that performs the proposed action on the environment in response to the evaluation agent determining that the proposed action should be implemented on the environment.

Some embodiments described herein may help to achieve a more efficient system for controlling an environment by enabling the system to produce and select better proposals. Additionally, some embodiments may increase the overall efficiency of the system in terms of scalability by reducing the number of potential proposals to be considered.

### BRIEF DESCRIPTION OF THE DRAWINGS

FIG. 1 illustrates a system including an intent manager that controls an environment using zero-touch control.

FIG. 2 illustrates elements of an intent manager that controls an environment using zero-touch control in more detail.

FIG. 3 illustrates an example of a mobile communication network that may be an environment controlled by an intent manager.

FIG. 4 illustrates an architecture of the intent manager according to some embodiments.

FIG. 5 is an example of a graph that illustrates relations between a plurality of agents and issues.

FIG. 6 illustrates example efficiency graphs for two possible situations.

FIG. 7 illustrates efficiency graphs that are stored in the knowledge base of the intent manager framework according to some embodiments.

FIG. 8 illustrates operations of various elements of an intent manager according to some embodiments.

FIG. 9 illustrates an example of the application of embodiments described herein in a network use case where an intent manager is deployed.

FIG. 10 illustrates operations of an intent manager according to some embodiments.

FIG. 11A is a block diagram illustrating elements of an intent manager according to some embodiments.

FIG. 11B illustrates various functional modules stored in the memory of the intent manager according to some embodiments.

### DETAILED DESCRIPTION OF EMBODIMENTS

As explained above, an issue arises when a measured KPI does not meet its target. This issue needs to be resolved, and the first step to achieve this is to propose one or more actions. Such action may, if taken, bring the KPI closer to its target. Multiple proposal agents may generate proposals for actions that should be taken to achieve the desired intent. However, to decide on an action proposal, intent manager must invoke the right proposal agent.

One way to do this is for each proposal agent 34b to register itself to the intent manager 10. The proposal agent 34b identifies the issues for which it could propose actions to address. For example, assume that the measured value of the latency KPI for a certain service KPI is 30 msec latency. Further assume that the target latency value is max 20 msec. The issue to be solved is that latency needs to be improved by at least 10 msec. In this example, there may be a proposal agent that registers itself with the information that it can propose actions for latency issues. When the latency issue proposal agent is invoked, it could perform a root cause analysis and, depending on the outcome, propose an action to address the latency issue, such as increasing the user plane priority of users involved in the service, decreasing the user plane priority of users of another service, increasing the data center compute capacity allocated to the service, etc.

In a second approach, instead of registering an ability to solve a particular issue, the proposal agent 34b would register the types of actions that it can propose. Following the example above, multiple proposal agents 34b would register with the intent manager 10. For example, one agent may register that it can propose the action “decrease user plane priority of some service.” A second proposal agent 34b may register that it can propose the action “increase user plane priority of a service.” A third proposal agent 34b may register that it can propose the action “increase the data center compute capacity of a service.”

In this second approach, each proposal agent 34b could still perform some root cause analysis, such as investigating how severe the issue is to determine how much the user plane priority should be increased, or for which service should user plane priority be increased. Still, the scope of the root cause analysis is smaller compared to the first approach. And, more importantly, additional logical inference rules are needed to tell the system that, upon a latency issue, certain agents need to be invoked. In this example, there may be multiple such rules, such as one rule saying, “upon a latency issue, invoke the decrease-user-plane-priority proposal agent,” or another rule saying, “upon a latency issue, invoke the increase-data-center-capacity proposal agent”, etc.

Note that the two approaches are not mutually exclusive, and that both may be used simultaneously in the same intent manager 10.

In both approaches, the intent manager 10 does not learn over time. Both approaches rely on decision rules, either provided by the proposal agent 34b as in the first approach or provided by another entity outside the proposal agent 34b as in the second approach. In this respect, the design is quite static because the rules do not change automatically, with the consequence that the intent manager 10 does not learn over time. This results in inefficiencies. For example, many actions are proposed in the second approach, but most of these actions would be discarded by the evaluation agent 34c. Since the system does not learn, inaccurate actions for a given issue may be proposed repeatedly. Another problem is missing solutions. With static rules, it could be that a potential solution for a given issue is not covered in the rules, since the human designer did not consider the possibility. Such missing solutions, in the form of missing action proposals, will never be proposed, and therefore never be evaluated and executed.

Certain aspects of the disclosure and their embodiments may provide solutions to these or other challenges. Some embodiments described herein provide a more dynamic approach in which the intent manager 10 learns over time which action proposals are best for a given issue. According to some embodiments, the decision rules for which proposal agent 34b to invoke are dynamic and may be added, changed or removed based on insights that the intent manager 10 gains over time.

Accordingly, for an issue that arises in a controlled environment 20, an intent manager 10 may invoke all available proposal agents 34b that are registered for solving the issue. That is, the intent manager 10 starts with zero knowledge of which 34b proposal agents are best for solving the issue in question.

Each proposal agent 34b generates one or more proposed actions, and the intent manager 10 performs a prediction/evaluation operation to decide what the expected outcome of each proposed action is.

The intent manager 10 monitors which proposed actions are accepted/rejected by the evaluation agent 34c. The accepted/rejected proposals are traced back to the knowledge base used for invoking the proposal agents 34b. Proposals that are rejected penalize the proposal agent 34b that made the proposal, while proposals that are accepted boost the efficiency of the proposal agent 34b that made the proposal.

When the system changes in some way, for example, a new intent is provided, a new actuator agent is added, etc., the system may slowly forget the previously learned efficiencies.

Certain embodiments may provide one or more of the following technical advantage(s). Some embodiments described herein may help to achieve a more efficient system for controlling the environment by enabling the system to produce and select better proposals. Additionally, some embodiments may increase the overall efficiency of the system in terms of scalability by reducing the number of potential proposals to be considered.

Some of the embodiments contemplated herein will now be described more fully with reference to the accompanying drawings. Embodiments are provided by way of example to convey the scope of the subject matter to those skilled in the art.

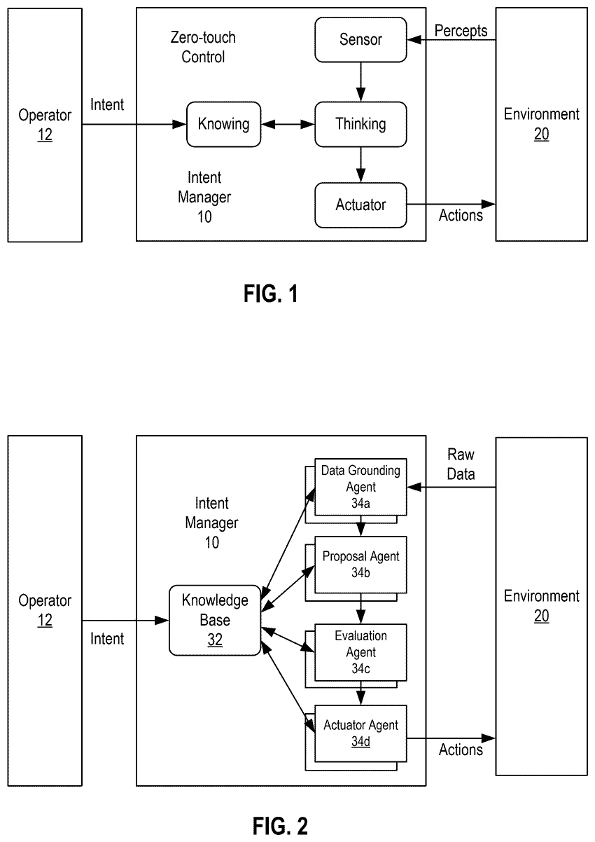

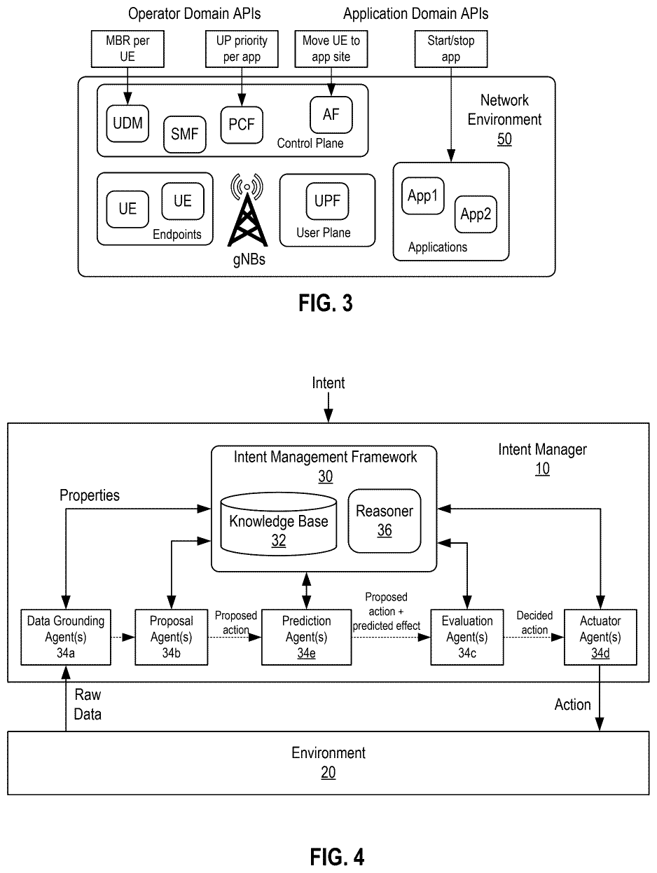

As explained above, the environment 20 shown in FIG. 2 may include a computerized system, such as a communication network or a portion thereof. FIG. 3 illustrates an example of a mobile communication network 50. In particular, the mobile communication network 50 contains a radio access network (containing gNodeBs/gNBs), a core network containing various network functions, such as a user plane function (UPF), policy control function (PCF), session management function (SMF), application function (AF), etc., as well as applications. Note that all these functions may be spread across multiple physical sites. For example, there may be multiple UPF instances at different sites. Similarly, the applications may come in multiple instances spread across local edge sites (close to the UPF) or national central sites. FIG. 3 also shows examples of actions that can be taken on the network. These actions, shown in the application programming interface (API) definitions, would be the actions that actuator agents can take on the mobile communication network 50.

FIG. 4 illustrates an architecture of the intent manager 10 according to some embodiments. In particular, the intent manager 10 includes an intent manager framework 30 that manages the operations of a plurality of agents, including one or more data grounding agents 34a, proposal agents 34b, prediction agents 34e, evaluation agents 34c and actuator agents 34d. The intent manager framework 30 includes the knowledge base 32, which stores KPIs, issues, network state and, as discussed in more detail below, one or more efficiency graphs. The intent manager framework 30 also includes a reasoner 36, which contains logic for controlling the actions of the agents 34a-34e based information stored in the knowledge base 32 and intents received from an operator 12.

The intent manager framework 30 manages the operations of the intent manager 10 to fulfill the intents provided by an operator 12. The data grounding agent(s) 34a receive raw data from the environment 20 and prepare the raw data for use by the proposal agents. The raw data is also provided to the reasoner 36 via the knowledge base 32 of the intent manager framework 30, which analyzes the data to identify issues that need to be resolved.

When target KPIs are not fulfilled, the reasoner 36 creates knowledge objects, called issues. For example, when the environment is a communication network, the information about the environment may include information relating to operation of the communication network, the intent may be a KPI of the communication network, and the issue may be a failure of the communication network to achieve the KPI.

The proposal agents 34b recognize the issues and assign themselves to produce solutions. The proposal agents 34b can be as diverse as needed and may implement many different procedures (e.g., if-then-else rules, reinforcement learning, optimization, and a mix of root cause analysis and rules) to solve the problem represented by an issue.

After actions are proposed by one or more proposal agents 34b, prediction agents 34e estimate the effect of the proposals on the environment 20 before the proposed actions are potentially executed. Conflicts are then analyzed on target KPIs. For example, a proposal may address one issue but create or exacerbate a different issue. Therefore, after the prediction agents 34e have predicted the effect of the proposed actions on the environment 20, the evaluation agents 34c resolve any conflicts identified during prediction. Finally, approved actions are executed by the actuator agents 34d.

According to some embodiments, the intent manager framework 30 learns which proposal agents 34b to invoke depending on which issues are present. The arrow between the proposal agents 34b and the intent manager framework in FIG. 4 indicates the communication needed for this type of “intelligent” invocation.

In previous approaches, all of the proposal agents 34b registered for solving a given issue will be called when the issue is addressed. All of the proposals generated by the proposal agents 34b will need to be evaluated. This can result in some inefficiency if proposals that are unlikely to be selected are generated by the proposal agents 34b.

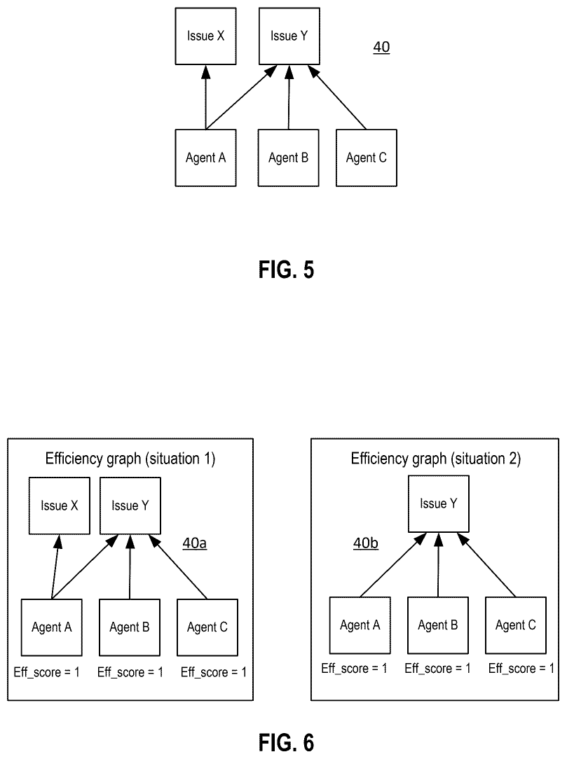

In the intent manager 10, several proposal agents may be registered for solving a particular issue. For example, FIG. 5 is an example of a graph that illustrates relations between a plurality of agents (A, B, C) and issues (X, Y). In the example of FIG. 5, Agent A declares that it can solve Issue X and Issue Y, while Agent B and Agent C can solve Issue Y. In previous approaches, when an issue such as an unmet KPI is identified, all of the proposal agents registered for solving that issue are invoked. In contrast, some embodiments described herein provide a more dynamic and intelligent way of invoking proposal agents.

In the following discussion, a “situation” is defined as the existence of a specific collection of issues in the system. For example, referring to FIG. 5, in a first situation (Situation 1), issue X and issue Y are both present. In a second, different situation (Situation 2), only Issue X is present.

According to some embodiments, the intent manager 10 keeps track of the efficiency of all of the proposal agents 34b at solving a particular situation and invokes the agents based on their efficiency. In this context, when a proposal agent 34b is invoked, the proposal agent 34b is requested by the intent manager framework 30 to generate a proposal of an action to be taken to address an identified issue. The efficiency of a proposal agent 34b with respect to a particular situation is variable, and is adjusted with each iteration based on whether or not the proposal generated by the proposal agent 34b was selected by the evaluation agents 34c to be applied to the environment 20.

The efficiencies of the proposal agents 34b may be represented on a so-called efficiency graph, which represents, for a given situation, both the relationships between proposal agents 34b and issues and the efficiencies of the proposal agents 34b at addressing the issues present in the situation.

FIG. 6 illustrates example efficiency graphs 40a, 40b for two possible situations (Situation 1 and Situation 2). The roots of an efficiency graph 40a, 40b represent the issues present in the situation, and the leaves of the efficiency graphs correspond to the proposal agents 34b that can be invoked for solving the issues present in the situation. For example, in FIG. 6, Situation 1 exists when both Issue X and Issue Y are present, while Situation 2 exists when only Issue Y is present. Only proposal agent A is registered as being capable of addressing Issue X, while proposal agents A, B and C are all registered as being capable of addressing Issue Y.

An efficiency score (Eff_score) is associated to each leaf of the graph 40a, 40b. The efficiency score may be a number in the rage [L,1]. In some embodiments, the efficiency score represents the probability of invoking the proposal agent for that situation. L, which is between 0 and 1, is the lowest allowable value of efficiency. L may be defined at design time, or may be adjustable at runtime.

In some embodiments, the efficiency score may be used as an absolute probability of invoking an agent. Alternatively, the intent manager 10 can adopt an epsilon-greedy approach for invocation, and invoke, with a certain probability Y, a proposal independently of its efficiency score.

Epsilon-greedy is a common approach used in reinforcement learning for selecting actions to balance exploration and exploitation. It involves selecting a random action with probability epsilon (a small value, often 0.1 or 0.01) and selecting the action that currently has the highest expected reward with probability 1-epsilon. This allows the agent to try new actions and explore its environment while also exploiting the knowledge it has gained about which actions tend to lead to high rewards.

In an example of epsilon-greedy approach, there may be a 5% probability the agent is always invoked regardless of its efficiency score, and a 95% probability that the invocation depends on the efficiency score (as explained above).

When all the efficiency scores are equal to 1, as in the example shown in FIG. 5, the system behaves like the baseline system. That is, for each issue, all the proposal agents 34b that are registered for solving the issue are invoked. According to some embodiments, a system with no knowledge always starts in this state. However, the efficiency scores are adjusted over time as proposals are made, selected, and applied to the environment 20.

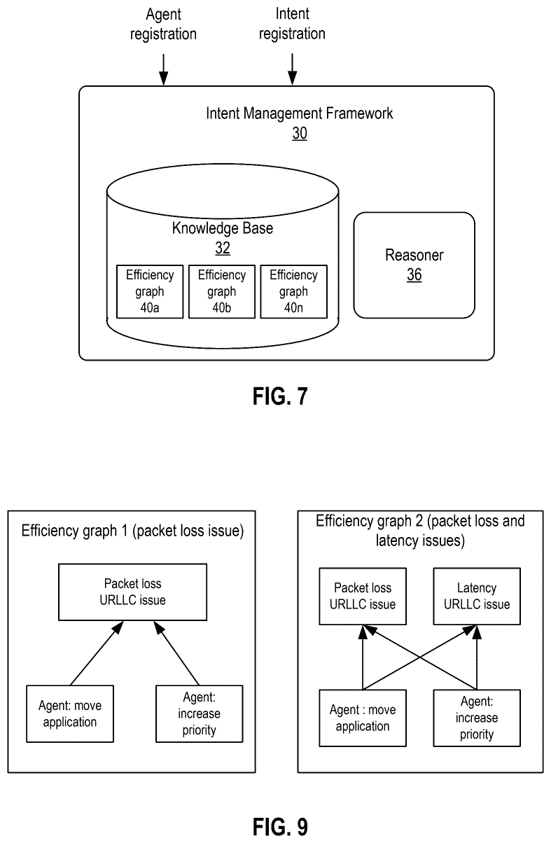

FIG. 7 illustrates that the efficiency graphs 40a-40n are stored in the knowledge base 32 of the intent manager framework 30. The efficiency graphs 40a-40n may be updated at runtime when a new intent (with new expectations) is registered. This triggers the creation of a new efficiency graph in the knowledge base.

The efficiency graphs 40a, 40b may also be updated when proposal agents are registered/unregistered in the intent manager 10. This triggers the update of the leaves of an already existing efficiency graph in the knowledge base.

The reasoner 36 of the intent manager framework 30 acts as a reasoning mechanism to invoke proposal agents 34b based on the information contained in the efficiency graphs 40a, 40b stored in the knowledge base 32.

As an example, assume that Situation 1 of FIG. 5 exists, and that Issues X and Y are present. In this example, each proposal agent 34b proposes a single action. For new issue(s) that pop up, the reasoner 36 will invoke all available proposal agents that are “registered” for solving that issue with a probability based on their efficiency score. Thus, Agents A, B, and C will be invoked, as their efficiency score is 1 (i.e., probability to be invoked =1). Each proposal agent A, B, and C generates one or more proposed actions. The proposed actions are analyzed by the prediction agents 34e and evaluation agents 34c. The intent management framework 30 monitors which proposed actions are accepted/rejected by the evaluation agents 34c and traces those actions back to the knowledge base 32 used for invoking the proposal agents 34b. For example, Action 2 from Agent 2 may be accepted while Action 1 and Action 3 (from Agents 1 and 3) may be rejected (i.e., discarded). When a proposal is rejected, the proposal agent 34b that made the proposal is penalized by a reduction in the efficiency score of that proposal agent 34b with respect to the particular situation being addressed. When a proposal is accepted, the efficiency score of the proposal agent 34b that made the accepted proposal is increased, up to a maximum of 1.

As a result of these operations, Agent 2 will be called with a higher probability than other agents when the situation appears again (because it was approved).

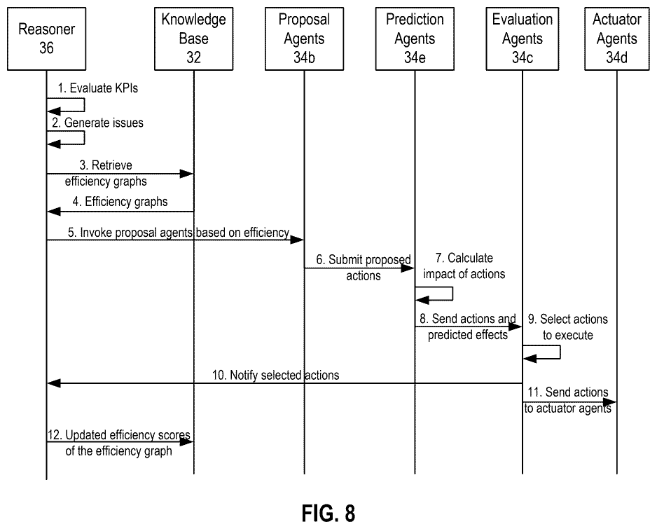

Abstracting from the concrete example presented above, the sequence diagram in FIG. 8 illustrates operations according to some embodiments in which the invocation of agents is based on their efficiency scores, and in which the efficiency graphs may be updated dynamically.

Referring to FIG. 8. In step 1 the reasoner 36 evaluates environment KPIs using the data obtained from the environment and information stored in the knowledge base 32. In step 2, the reasoner 36 generates issues (i.e., unmet expectations) to be addressed. In step 3, the current issues are used to define a situation, and the efficiency graph 40a representing the situation is retrieved from the knowledge base 32 (step 4).

In step 5, the reasoner 36 invokes one or more proposal agents 34b based on the information in the efficiency graph 40a. That is, the reasoner 36 determines whether or not to invoke a particular proposal agent 34b based on a probability of invocation derived from the information stored in the efficiency graph 40a. For example, in some embodiments, the proposal agent 34b may be invoked with a probability equal to the efficiency score of the proposal agent 34b. In other embodiments, there may be a fixed probability (epsilon) that the proposal agent 34b is invoked, and a probability (1-epsilon) that invocation of the proposal agent 34b is based on the efficiency score of the proposal agent 34b (i.e., a probability epsilon that the proposal agent 34b will be invoked and a probability 1-epsilon that the proposal agent 34b may or may not be invoked based on the efficiency score of the proposal agent 34b).

In step 6, the proposal agents 34b propose actions that in step 7 will be evaluated by the prediction agents 34e. In step 8, the prediction agents 34e will send the actions and their predicted effects to the evaluation agents 34c. In step 9, the evaluation agents 34c select the actions to be executed.

In step 10, the evaluation agents 34c notify the reasoner 36 of the selected actions. In step 11, the evaluation agents 34c send the actions to the actuator agents for execution.

In step 12, the reasoner 36 updates the efficiency graph 40a based on which actions were selected. As noted above, if an action is selected, the efficiency score of the proposal agent 34b that proposed the action is increased, and in an action is not selected, the efficiency score of the proposal agent 34b that proposed the action is decreased.

If an agent proposes multiple actions, its efficiency score may be increased if at least one of the proposed actions was accepted after evaluation. Optionally, the intent manager 10 may send feedback to the proposal agents 34b that were rejected requesting them not to propose the rejected actions for that situation in the future.

In some embodiments, the efficiency scores may be updated after evaluation by the evaluation agents 34c. In some embodiments a fixed update may be performed. For example, a bonus/malus constant K may be defined at design time (for example, K=0.1). When a proposal agent 34b proposes an action that is approved, its new efficiency score is increased by K, otherwise the efficiency score is decreased by K.

In some embodiments, the efficiency scores may be updated dynamically. For example, in the intent manager 10, every intent may have an associated penalty formula. The penalty may be a function of all of the intents' penalties, e.g., sum of all the intent penalties. In the dynamic update implementation, the bonus/malus is proportional to the delta intent manager penalty after prediction/evaluation, where the delta penalty is the current intent manager penalty minus the predicted intent manager penalty for the action proposed.

In some embodiments, when something changes in the intent manager 10, such as when a new intent is provided, the intent manager 10 may update the efficiency scores of each efficiency graph with the aim of allowing better learning in existing and new situations and to avoid drift of the learning. By doing so, the IM may slowly forget what it learned when the dynamic event occurs. For example, the efficiency scores may be reset to, or increased toward, the value 1.0 (representing the highest probability of being invoked).

In some embodiments, a constant U may be defined at design time to smooth the variance between the efficiency scores of proposal agents 34b that may be invoked for a given situation. For example, U=0.2, in which case, when a new intent is received, or new expectations are provided, or a predetermined time period has elapsed, all of the efficiency scores may be increased by 20%.

This update can be also triggered upon notification from another module that is responsible for identifying level of dynamism in the network in a more accurate way.

In some embodiments, when a new situation arises, because of new expectations are registered, instead of initializing new efficiency graphs with efficiency scores=1 the intent manager may adopt transfer learning. In that case, the efficiency scores of the agents for the new situations may be initialized with the efficiency score of the most similar situation already present in the system. The most similar situation may be defined as the one with most issues in common with the new situation.

Yet another aspect of dynamicity is elapsed time. For example, network traffic situations are typically quite different day-time vs night-time. Problems that are seen in peak hours may not arise in dip hours. To cater for such dynamicity, the system can simply update the efficiency scores upwards (that is, towards the highest probability) when a certain period of time has passed.

Another aspect of dynamism relates to creating new edges between agents and issues. By creating new edges in the efficiency graph, the system learns new rules and increments the number of proposals that can solve issues. Without the efficiency graph, such an approach could hinder the system by increasing the number of recommended proposals. However, the efficiency graph makes this approach more scalable, since it prunes inefficient recommendations.

Adding new edges aims to identify actions that, when executed, affect KPIs expressed in the issues. One possible implementation is based on supervised learning. In it, the system would try to learn a model, M, that maps the effect of an executed action to the KPIs expressed in the expectations. The impact of an action is defined by the difference between the KPI values before and after the execution.
M is defined below:
M(O, S0, S1, C0)=(C1, A1,) where:
O: represent parameters for model M;
S0: represents the KPI values before the action execution;
S1: represents the KPI values after the action execution;
C0: represents the current network configuration;
C1: the proposed action (or the new network configuration);
A1: the agent who proposed the action.

Once M is available, it can be queried to add new edges to efficiency graphs, as represented in FIG. 6. As an example, in situation 1, the system queries the model M with the current state (S0), the goal state to fix issue X (S1), and the current network configuration (C0). Then, based on the output of the model M, a new edge may be added between Agent B and Issue X if it is determined that an action that Agent B can take can address Issue X.

Other mechanisms and formulations can be used to add new edges to the efficiency graph. Because efficiency graphs can be expanded, it is feasible to expand the number of proposals, since the efficiency graph guarantees that the number of proposals remains manageable.

FIG. 9 illustrates an example of the application of embodiments described herein in a network use case where an intent manager 10 is deployed. In particular, in the example illustrated in FIG. 9, a URLLC intent is submitted to the intent manager 10. Two non-functional expectations associated with the URLLC application are: latency <50 ms for all the users of the service and packet loss less than 1% for all the users of the service.

Since this is the only intent in the system, all of its expectations are now satisfied. However, assume that a new intent is inserted in the system that requires that the QoE for 80% of the users of a video service must be greater than 4.0. Video traffic is known to be very aggressive on network resources, so it causes the URLLC application to behave poorly. Specifically, some of the URLCC expectations might now be unmet while the video service's expectations are fully met. By applying the systems/methods described herein, the best/correct proposal agent 34b may be invoked depending on the severity of the situation for the URLLC service.

FIG. 9 illustrates an example of efficiency graphs for two different situations, namely, an efficiency graph 1 where only packet loss is violated for the URLLC service and an efficiency graph 2 where both packet loss and latency issues are present. For both the situations two proposal agents 34bv can be invoked, including a proposal agent 34b that increases the priority of the application and a proposal agent 34b that moves the context of the application to a new site.

In the baseline approach, no matter which situation is present, both proposal agents 34b will be invoked to try to solve the issues. However, that would result in inefficiencies, because all the action proposals would need to be predicted and evaluated, which requires more computation and hence more energy consumed by the hardware on which the intent manager 10 is running.

Moreover, some proposals may require a long time to be evaluated, with the risk of blocking the closed loop of monitoring, proposing, predicting, and actuating, and hence increasing the resolution time of the closed loop.

According to some embodiments, the intent manager 10 has already faced the situations at hand and has stored and updated the related efficiency graphs 40a in the knowledge base 32.

When situation 1 is faced (i.e., packet loss issue, shown on the left side of FIG. 9, the proposal agent 34b proposing to increase the priority of the application may be invoked with a higher probability than the proposal agent 34b proposing to move the application context.

Indeed, in this scenario it may be experienced that moving the application context is effective but has a high cost for the intent manager (e.g., higher penalty). On the other side, the increase priority action may still be effective while requiring less cost (e.g., moving the application in a new site might require instantiating new virtual machines where to move the application context). Hence, in this situation the following may be true for efficiency graph 1:
Move application: eff_score=0.2
Increase priority: eff_score=0.98

When situation 2 is faced (i.e., packet loss and latency issues, right side of FIG. 9), the proposal agent 34b that proposes moving the application context may be invoked with a higher probability than the proposal agent 34b proposing to increase the priority of the application. That is, the opposite of what happened in the previous case may occur. Increasing the priority of the URLLC application may not be enough to solve the issues, and a complete move of the application context may be necessary for solving both latency and packet loss issues. Hence, in this situation the following may be true:
Move application: eff_score=0.99
Increase_priority: eff_score=0.5

Some embodiments can be applied to other use cases, as the concept of “problems” or “issues” and “agents” solving them can be instantiated similarly for different use cases. For example, an environment may include a real-world environment, such as a technical system that includes sensors, actuators, processors, and other components. The technical system may, for example, include a communication network where the “agents” may be electronic agents or software agents, etc. The communication network includes actuators, such as base stations, that can be controlled to affect the operation of the network.

In some embodiments, the environment may be a smart factory that includes intelligent mechanical systems that include both processing circuits and actuators, such as robots, conveyor belts, etc., that are controlled by processing units.

In a smart factory, robots with specific capabilities may be registered with a robot coordination to solve issues or requirements (e.g., tasks such as move package, wrap package, etc . . . ). When a requirement is set, the intent manager learns which robot is best to call. For simple situations, a generic robot might be invoked for solving the problem. Complex situations, on the other side, might require the use of very specialized robots that are very costly to operate.

By applying embodiments described herein to the context of the smart factory use case, a robot manager can learn over time which set of robots to invoke for the tasks at hand to solve. This allows for the coordinator to determine, for example, whether it should invoke one specialized robot or multiple generic robots.

A similar approach can be applied for learning where to dispatch a support call (i.e., to which operator in a call center) based on the problems at hand of the customer. Different operators may be evaluated with respect to their capabilities of solving issues. When a customer of the call center register for solving certain issues the dispatching call system automatically redirect the call to the operator that is expected to perform better for that situation.

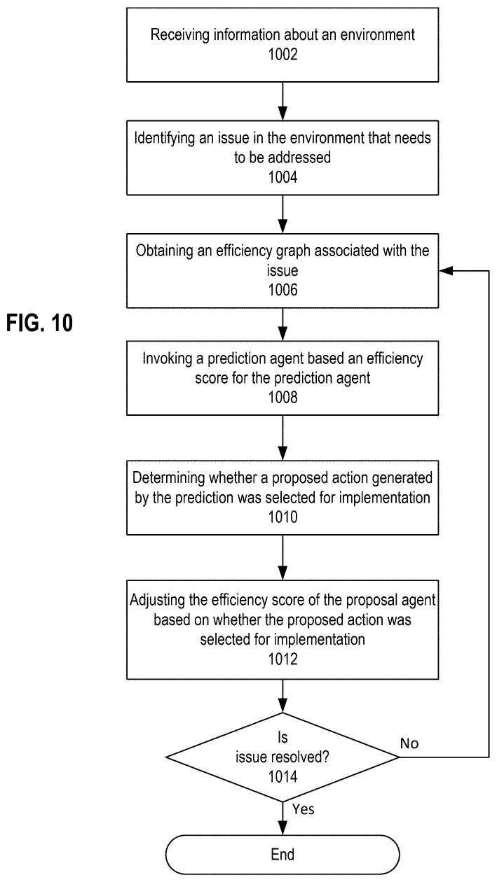

FIG. 10 illustrates operations of an intent manager 10 that controls an environment based on an intent for the environment 20 according to some embodiments. Referring to FIGS. 4 and 10, the method includes receiving information about the environment (1002). Information may be received from the environment, for example, via a data grounding agent 34a that receives raw data from the environment, processes the data, and stores the data in a knowledge base 32 in an intent manager framework 30 of the intent manager 10. The data may be retrieved from the knowledge base 32 by a reasoner 36 in the intent manager framework 30.

Based on the information about the environment, the reasoner 36 identifies an issue in the environment that needs to be addressed to achieve the intent (block 1004).

Once the issue has been identified, the reasoner 36 obtains an efficiency graph associated with the issue (block 1006). For example, the efficiency graph may be retrieved from the knowledge base 32 The efficiency graph indicates an efficiency score of a plurality of proposal agents 34b including a first proposal agent 34b at generating proposed actions on the environment to address the issue. In some embodiments, the efficiency graph may be associated with a situation that includes multiple issues and that associates proposal agents 34b with issues that the proposal agents can address.

Based on the efficiency score of the first proposal agent, the reasoner 36 invokes the first proposal agent 34b to generate a proposed action on the environment to address the issue (block 1008). In particular, the reasoner 36 may decide to invoke the first proposal agent 34b based on a probabilistic function that uses the efficiency score of the first proposal agent 34b as an input parameter as described above.

The intent manager 10 then determines whether or not the proposed action generated by the first proposal agent is selected for implementation on the environment (block 1010). This determination may made by generating a prediction of the effect the proposed action will have on the environment 20 and evaluating the proposed action based on the prediction.

The reasoner 36 then adjusts the efficiency score of the first proposal agent based on whether or not the proposed action generated by the first proposal agent was selected for implementation on the environment (block 1012).

The reasoner 36 then determines whether or not the issue has been resolved at block 1014, and if so, the procedure ends. Otherwise, operations return to block 1006, and the reasoner 36 obtains the modified efficiency graph and repeats the process of invoking proposal agents based on the modified efficiency graph.

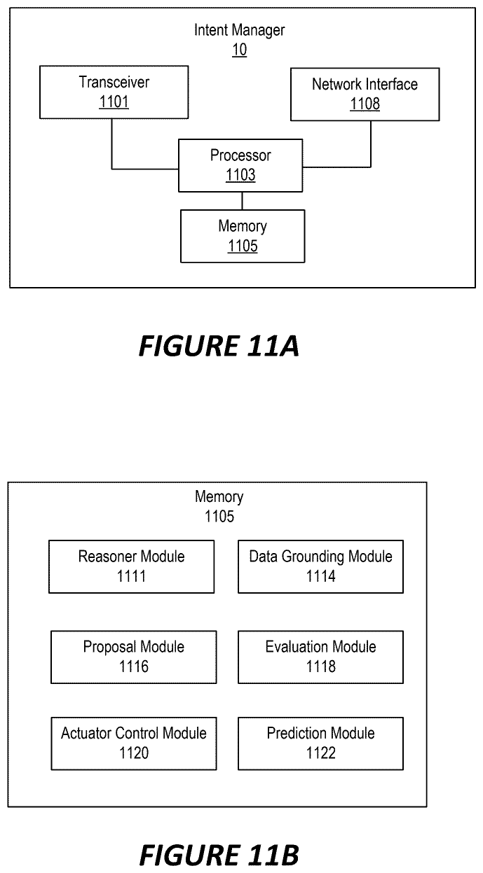

FIG. 11A is a block diagram illustrating elements of an intent manager 10 according to some embodiments. The intent manager 10 may be provided by, e.g., a device in the cloud running software on cloud computing hardware; or a software function/service governing or controlling a communication network. That is, the device may be implemented as part of a communications system, or on a device as a separate functionality/service hosted in the cloud. The device also may be provided as a standalone software for managing a communication network; and the device may be in a deployment that may include virtual or cloud-based network functions (VNFs or CNFs) and even physical network functions (PNFs). The cloud may be public, private (e.g., on premises or hosted), or hybrid.

As shown, the device may include transceiver circuitry 1101 (e.g., RF transceiver circuitry) including a transmitter and a receiver configured to provide uplink and downlink radio communications with devices (e.g., a controller for automatic execution of actuations). The device may include network interface circuitry 1108 (also referred to as a network interface,) configured to provide communications with other devices (e.g., a controller for automatic execution of an actuation). The device may also include processing circuitry 1103 (also referred to as a processor) coupled to the transceiver circuitry, memory circuitry 1105 (also referred to as memory) coupled to the processing circuitry.

As discussed herein, operations of the device may be performed by processing circuitry 1103, network interface 1108, and/or transceiver 1101. For example, processing circuitry 1103 may control the intent manager 10 to perform operations according to embodiments disclosed herein. Processing circuitry 1103 also may control transceiver 1101 to transmit downlink communications through transceiver 1101 over a radio interface to one or more devices and/or to receive uplink communications through transceiver 1101 from one or more devices over a radio interface. Similarly, processing circuitry 1103 may control network interface 1108 to transmit communications through network interface 1108 to one or more devices and/or to receive communications through network interface from one or more devices. Moreover, modules may be stored in memory 1105, and these modules may provide instructions so that when instructions of a module are executed by processing circuitry 1103, processing circuitry 1103 performs respective operations (e.g., operations discussed below with respect to example embodiments relating to devices). According to some embodiments, the intent manager 10 and/or an element(s)/function(s) thereof may be embodied as a virtual device/devices and/or a virtual machine/machines.

According to some other embodiments, a device may be implemented without a transceiver. In such embodiments, transmission to a wireless device may be initiated by the intent manager 10 so that transmission to the wireless device is provided through a device including a transceiver (e.g., through a base-station). According to embodiments where the device includes a transceiver, initiating transmission may include transmitting through the transceiver.

FIG. 11B illustrates various functional modules stored in the memory 1105 of the intent manager 10. In particular, the memory 1105 may include a reasoner module 1112 that implements the reasoner 36 of the intent manager 10. The memory 1105 may also include a data grounding module 1114 for implementing the data grounding agent(s) 34a, a proposal module 1116 for implementing the proposal agent(s) 34b, an evaluation module 1118 for implementing the evaluation agent(s) 34c, an actuator control module 1120 for implementing the actuator agent(s) 34d, and/or a prediction module 1122 for implementing the prediction agent(s) 34e. It will be appreciated that in various embodiments, one or more of the data grounding agent(s) 34a, the proposal agent(s) 34b, the evaluation agent(s) 34c, the actuator agent(s) 34d, and/or the prediction agent(s) 34e may be implemented separately from the intent manager 10.

Other modules may also be provided in the memory 1205 to effect the operations described above.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by an intent manager that controls an environment based on an intent for the environment, the method comprising:
receiving information about the environment;
based on the information about the environment, identifying an issue in the environment that needs to be addressed to achieve the intent;
obtaining an efficiency graph associated with the issue, wherein the efficiency graph indicates an efficiency score of a first proposal agent at generating proposed actions on the environment to address the issue;
based on the efficiency score, invoking the first proposal agent to generate a proposed action on the environment to address the issue;
determining whether or not the proposed action generated by the first proposal agent is selected for implementation on the environment; and
adjusting the efficiency score of the first proposal agent based on whether or not the proposed action generated by the first proposal agent was selected for implementation on the environment.

2. The method of claim 1, wherein adjusting the efficiency score of the first proposal agent comprises increasing the efficiency score of the first proposal agent in response to the proposed action generated by the first proposal agent being selected for implementation on the environment, and decreasing the efficiency score of the first proposal agent in response to the proposed action generated by the first proposal agent not being selected for implementation on the environment.

3. The method of claim 1, wherein the efficiency score indicates a probability of being invoked to generate a proposed action on the environment to address the issue.

4. The method of claim 3, wherein the efficiency score comprises a value between 0 and 1 inclusive.

5. The method of claim 3, wherein the efficiency score comprises a value between L and 1 inclusive, where L is a lower limit of the efficiency score that is greater than zero and less than 1.

6. The method of claim 1, wherein invoking the first proposal agent to generate the proposed action on the environment to address the issue based on the efficiency score comprises invoking the first proposal agent with a probability equal to the efficiency score of the first proposal agent.

7. The method of claim 6, wherein invoking the first proposal agent to generate the proposed action on the environment to address the issue is based on a probability value that is independent of the efficiency score of the first proposal agent.

8. The method of claim 7, wherein the invoking the first proposal agent to generate the proposed action on the environment to address the issue is performed with a probability value epsilon without reference to the efficiency score of the first proposal agent and a probability value 1-epsilon based on the efficiency score of the first proposal agent.

9. The method of claim 1, wherein the efficiency graph indicates efficiency scores of a plurality of proposal agents, including the first proposal agent, at generating proposed actions on the environment to address the issue.

10. The method of claim 9, wherein the notification indicates whether or not the proposed actions generated by the plurality of proposal agents were selected for implementation on the environment, the method further comprising:
adjusting the efficiency scores of each of the plurality of proposal agents based on whether or not the proposed actions generated by the plurality of proposal agents were selected for implementation on the environment.

11. The method of claim 1, wherein the first proposal agent generates a plurality of proposed actions to address the issue, and wherein the efficiency score of the first proposal agent is increased in response to any of the plurality of proposed actions being selected for implementation on the environment.

12. The method of claim 1, wherein the environment comprises a computerized system, the information about the environment comprises information relating to operation of the computerized system, the intent comprises a key performance indicator, KPI, of the computerized system, and the issue comprises a failure of the computerized system to achieve the KPI.

13. The method of claim 12, wherein the environment comprises a communication network, the information about the environment comprises information relating to operation of the communication network, the intent comprises a key performance indicator, KPI, of the communication network, and the issue comprises a failure of the communication network to achieve the KPI.

14. The method of claim 1, wherein the issue comprises a first issue, and wherein the efficiency graph is associated with a situation that includes a plurality of issues including the first issue.

15. The method of claim 1, further comprising:
detecting a change in the intent or a change in the issue; and
updating the efficiency score in response to the change in the intent or the change in the issue.

16. (canceled)

17. The method of claim 15, wherein updating the efficiency score comprises increasing the efficiency score to a maximum value.

18. The method of claim 15, wherein updating the efficiency score comprises increasing the efficiency score by a fixed percentage.

19. (canceled)

20. (canceled)

21. The method of claim 1, wherein updating the efficiency score comprises delaying increasing or decreasing the efficiency score until after determining that a predetermined time period has elapsed.

22. (canceled)

23. The method of claim 1, further comprising adding one or more edges to the efficiency graph based on a model, M, that maps the effect of executed action to the issue.

24. An intent manager that controls an environment based on an intent for the environment, the intent manager comprising at least one processor executing instructions from at least one memory, the instructions executed from the at least one memory comprising:
a reasoner that receives information about the environment and, based on the information about the environment, identifies an issue in the environment that needs to be addressed to achieve the intent, wherein the reasoner obtains an efficiency graph associated with the issue, wherein the efficiency graph indicates an efficiency score of a first proposal agent at generating proposed actions on the environment to address the issue, and wherein, based on the efficiency score, the reasoner invokes the first proposal agent to generate a proposed action on the environment to address the issue; and
an evaluation agent that determines whether or not the proposed action generated by the first proposal agent is selected for implementation on the environment, and that notifies the reasoner of whether or not the proposed action generated by the first proposal agent was selected for implementation on the environment;
wherein the reasoner adjusts the efficiency score of the first proposal agent based on whether or not the proposed action generated by the first proposal agent was selected for implementation on the environment.

25-47. (canceled)
